(19) United States
(12) Patent Application Publication
(10) Pub. No.: US 2023/0420707 A1
(43) Pub. Date: Dec. 28, 2023

(54) WATER SEPARATOR WITH THROTTLE ELEMENT AND FUEL CELL SYSTEM WITH WATER SEPARATOR

(71) Applicant: MANN+HUMMEL GmbH, Ludwigsburg (DE)

(72) Inventors: Andreas WEBER, Freiberg (DE); Ettore NOCERA, Besigheim (DE)

(21) Appl. No.: 18/464,037

(22) Filed: Sep. 8, 2023

Related U.S. Application Data
(63) Continuation of application No. PCT/EP2022/056040, filed on Mar. 9, 2022.

(30) Foreign Application Priority Data
Mar. 25, 2021 (DE) 102021107639.0

(51) Int. Cl. H01M 8/04119; B01D 45/16; H01M 8/0662

(52) U.S. Cl. CPC H01M 8/04164; B01D 45/16; H01M 8/0662

(57) ABSTRACT

A water separator including a flow-conducting interior, and a water outlet connected to the flow-conducting interior, the water outlet including a throttle element that is inserted in the water outlet and configured to conduct water flow into the throttle element. The throttle element includes a first channel section including a conical section tapering in a direction of the water flow into the first channel section, a constriction directly connected to an output of the first channel section, the constriction including a cylindrical section, and a cylindrical channel section directly connected to an output of the constriction, the cylindrical channel section having a cross-section that is larger than a cross-section of the constriction.

### CROSS-REFERENCE TO RELATED APPLICATIONS

This application is a continuation application of International Application No. PCT/EP2022/056040 filed on Mar. 9, 2022, which claims the benefit of German Application No. 102021107639.0 filed on Mar. 26, 2021, the entire disclosures of which are incorporated herein by reference for all purposes.

### BACKGROUND

The invention concerns a water separator with a throttle element, a use of a water separator, and a fuel cell system with a water separator.

EP 1167743 B1 discloses a water separator which is embodied as a spin separator. The water separator includes an inner tube and an outer tube which are arranged sequentially in axial direction, wherein the inner tube projects with an axial section into the outer tube and the outer tube includes a water outlet arranged tangentially in the spin direction.

### SUMMARY

An object of the invention is to provide an improved water separator.

A further object of the invention is to specify a use of a water separator.

A further object resides in providing a fuel cell system with such a water separator.

The aforementioned objects are solved according to an aspect of the invention by a water separator, including a flow-conducting interior and a water outlet connected to the interior, wherein the water outlet includes a flow-conducting throttle element which is embodied as an insert part and embedded with form fit and/or friction fit in the water outlet.

According to a further aspect of the invention, the objects are solved by a use of a water separator for gas flow limitation in a drainage conduit.

According to a further aspect of the invention, the objects are solved by a fuel cell system with a cathode supply air path and a cathode exhaust air path of a fuel cell unit and with at least one water separator according to the invention, wherein the at least one water separator is arranged in the cathode exhaust air path and provided for air flow limitation in a drainage path of the water separator.

Beneficial embodiments and advantages of the invention result from the additional claims, the description, and the drawing.

According to an aspect of the invention, a water separator is proposed, including a flow-conducting interior and a water outlet connected to the interior, wherein the water outlet includes a flow-conducting throttle element which is embodied as an insert part and embedded with form fit and/or friction fit in the water outlet.

Since the insert part is embedded in the water outlet, no additional seals or fastening means are required in order to connect the throttle element to the water outlet. This is beneficial regarding costs. In addition, the assembly is simplified. Furthermore, this is beneficial for the service life of the throttle element.

Advantageously, the water separator can be formed of plastic material. Preferably, at least the water outlet is formed of plastic material.

Advantageously, the water separator can be embodied as a spin separator in which the water outlet is arranged tangentially in spin direction in the intended state.

In an alternative embodiment, the water separator can be configured as a spin separator in which the water outlet is arranged radially in outward direction and at an angle relative to the longitudinal axis.

Beneficially, the interior of the water separator includes an inner tube and an outer tube which are arranged sequentially in axial direction, wherein the inner tube includes a smaller diameter than the outer tube at the transition to the outer tube and the outer tube includes the water outlet.

According to a beneficial embodiment of the water separator, the throttle element can be embedded by means of a heated insert method or injection molding method into the water outlet.

In the heated insert method, also referred to as heat-set insert method, the insert part is heated and is pressed into a hollow space of the water outlet. The temperature of the insert part melts locally the plastic material of the water outlet. After solidification, the insert part is fixedly connected, in particular with form fit, to the material of the water outlet.

In the injection molding method or overmolding method, the insert part is inserted into the corresponding tool and overmolded with the material, in particular plastic material, which forms the water outlet or the water separator. After solidification of the plastic material, the insert part is fixedly surrounded, in particular with form fit, at least partially by the material of the water outlet.

Alternatively, other fastening methods are conceivable with which the insert part can be embedded in the water outlet. For example, the insert part can be provided with an outer thread, in particular a self-cutting outer thread, and screwed into the water outlet.

According to a beneficial embodiment of the water separator, the throttle element can include a constriction with a diameter between 1 mm and 4 mm, in particular between 1.5 mm and 3 mm. The constriction permits the exit of water, but limits the exit of the gas being dehumidified in the water separator. The length of the constriction in flow direction can be selected depending on the desired field of use and the boundary conditions existing there.

Advantageously, the flow-conducting throttle element, embodied as an insert part, includes, in a first section in flow direction, a tapering, in particular conical, inflow cross section which is adjoined by the actual throttle region with minimal diameter. For example, the throttle region can be configured as a cylindrical channel section which is short in relation to the total throttle element. A channel section with an expanding cross section which slows the flow and absorbs the energy of the fluid flowing at high speed through the throttle region can adjoin the throttle region downstream. The expanding cross section can include, for example, a sudden or continuous cross-sectional expansion. With such a configuration, a material with reduced resilience compared to the material of the throttle element can be employed downstream of the throttle element. Downstream of the throttle element, the fluid can be conducted in a plastic conduit or an elastomer hose, for example.

In an alternative embodiment, the flow-conducting throttle element includes a first cylindrical cross section and a second short cylindrical cross section as the throttle region with a significantly smaller cross section, adjoining downstream. A third channel section with a larger cross section, for example, with a cross section that is identical to or similar to the cross section of the first channel section, can adjoin the throttle region.

According to a beneficial embodiment of the water separator, the throttle element can be formed of metal or plastic material or ceramic. The use of metal enables particularly advantageously a throttle element with very fine structures such as, for example, constrictions of very small dimensions which can be produced of plastics only with very high-quality and expensive plastic materials.

According to a beneficial embodiment of the water separator, the throttle element can be embodied for a flow speed near the speed of sound of the fluid, in particular at least 90% of the speed of sound, for special operating states. Due to embedding the throttle element in the water outlet, the throttle element can permanently withstand even high loads.

According to a beneficial embodiment of the water separator, the throttle element can include a cylinder-shaped outer wall. This shape is beneficial for a heated insert method in order to embed the throttle element as an insert part in the water outlet.

A knurled structure or other depressions at the outer wall of the throttle element are particularly advantageous in order to create a form fit with the material of the water outlet.

According to a beneficial embodiment of the water separator, the throttle element can include a cylinder-shaped outer wall which includes at the outer circumference one or a plurality of circumferentially extending grooves or corrugations, extending in axial direction or at an angle relative to the longitudinal direction, or knurled structures. Conceivable are also curved depressions at the wall surface or individual depressions in the form of bores or indentations. Individual shapes thereof or a combination of the shapes are advantageous for an injection molding process in which the throttle element, as an insert part, is placed into an injection molding tool and can become wedged captively with the surrounding plastic material by means of the structured outer surface.

According to a beneficial embodiment of the water separator, the interior of the water separator can be embodied for spin separation of the water.

In the interior, the water separator can advantageously include an outer tube which includes an expanding separation region for the water. In the interior, the water separator can include furthermore advantageously an inner tube which includes an expanding slowing region. The water outlet can be connected likewise advantageously to the interior by a funnel-shaped region.

According to a further aspect of the invention, a use of a water separator according to the invention is proposed for gas flow limitation in a drainage conduit which transports liquid which has been extracted from a gas flow. The water separator includes a flow-conducting interior and a water outlet connected to the interior, wherein the water outlet includes a flow-conducting throttle element which is embodied as an insert part and embedded with form fit and/or friction fit in the water outlet. Due to embedding the throttle element in the water outlet, a loss of a portion of the gas flow exiting together with the separated water from the water outlet can be limited.

Additional seals and connection means can be saved. The connection between throttle element and water outlet is advantageously permanently fixed even at high loads.

According to a further aspect of the invention, a fuel-cell system is proposed with a cathode supply air path and a cathode exhaust air path of a fuel cell unit and with at least one water separator according to the invention, wherein the at least one water separator is arranged in the cathode exhaust air path and provided for air flow limitation in a drainage path.

In a further advantageous embodiment of the invention, the water separator according to the invention can be arranged in the anode circuit of a fuel cell system in order to separate water, for example, prior to entering into the fuel cell.

Advantageously, the throttle element can reduce a loss of the exhaust air of the fuel cell system so that a turbine of a turbocharger driven by the exhaust air can be operated at high efficiency.

Due to embedding the throttle element in the water outlet, a loss of a portion of the gas flow which is exiting together with the separated water from the water outlet can be limited. Additional seals and connecting means can be saved. The connection between throttle element and water outlet is advantageously permanently fixed even at high loads.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a side view of a water separator according to an embodiment of the invention with partially sectioned water outlet.

FIG. 2 shows a section illustration of the water separator with a throttle element according to FIG. 1.

FIG. 3 shows an enlarged detail of the section illustration of the throttle element of FIG. 2.

FIG. 4 shows a plan view of the water separator of FIG. 1 with funnel-shaped water outlet.

FIG. 5 shows an isometric view of a first embodiment of a throttle element.

FIG. 6 shows a side view of the throttle element of FIG. 5.

FIG. 7 shows a section through the throttle element of FIG. 5.

FIG. 8 shows an isometric view of a further embodiment of a throttle element.

FIG. 9 shows a side view of the throttle element of FIG. 8.

FIG. 10 shows a section through the throttle element of FIG. 8.

FIG. 11 shows an isometric view of a further embodiment of a throttle element.

FIG. 12 shows a side view of the throttle element of FIG. 11.

FIG. 13 shows a section of the throttle element of FIG. 11.

FIG. 14 shows a simplified illustration of a fuel cell system with cathode supply air path and cathode exhaust air path.

### DETAILED DESCRIPTION

In the Figures, same or same-type components are identified with same reference characters. The Figures show only examples and are not to be understood as limiting.

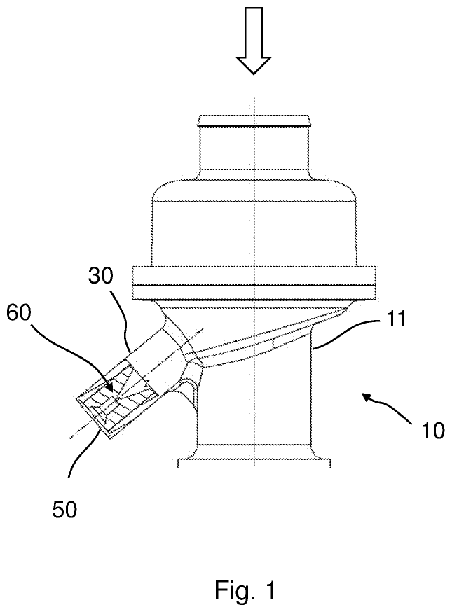

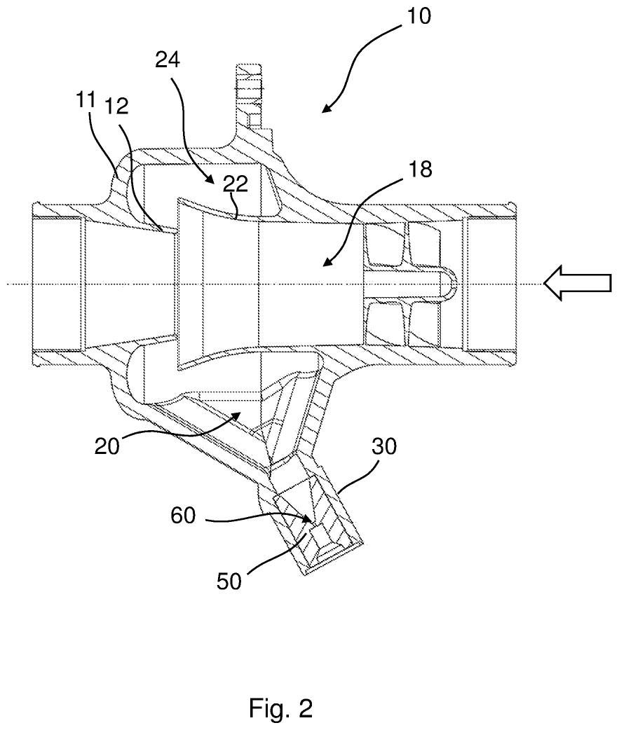

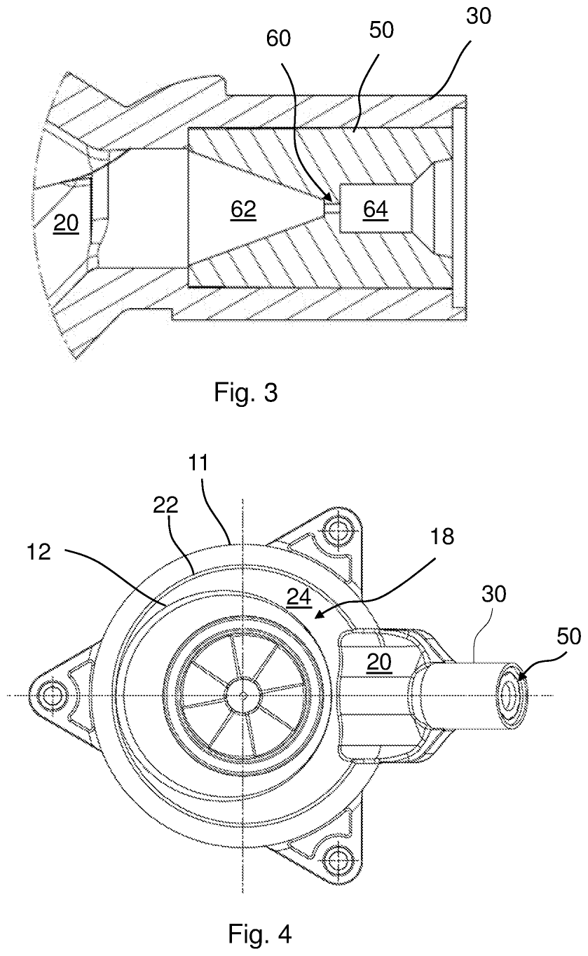

For explaining the invention, FIGS. 1 to 3 show an embodiment of the invention. FIG. 1 shows a water separator 10 in a vertical arrangement in a side view with partially sectioned water outlet 30. The inlet of the fluid in this illustration is from the top, the water outlet at the side. FIG. 2 shows a section illustration of the water separator 10 in a horizontal arrangement with a flow-conducting throttle element 50 according to FIG. 1. The inlet of the fluid in this illustration is from the right, the water outlet downward. FIG. 3 shows an enlarged detail of the section illustration of the throttle element 50 of FIG. 2.

The water separator 10 is embodied beneficially as spin separator and includes, in an interior 18 of a housing 11, an inner tube 12 and an outer tube 22 which are arranged sequentially in axial direction. The inner tube 12 includes at the transition to the outer tube 22 a smaller diameter than the outer tube. The outer tube 22 includes a pin-shaped water outlet 30, wherein, at the free end of the water outlet 30, the throttle element 50 is arranged which is embodied as an insert part and embedded with form fit and/or friction fit in the water outlet 30.

The transition between inner tube 12 and outer tube 22 is arranged within a separation region 24 of the water separator 10 which is adjoined by the pin-shaped water outlet 30 via a funnel-shaped region 20. In this way, separated water can be collected and guided to the water outlet 30 due to the acting force of gravity.

This is illustrated in detail in FIG. 4 which shows a plan view of the water separator 10 of FIG. 2 with the funnel-shaped region 20 between interior 18 and the pin-shaped water outlet 30. The water outlet 30 extends from the centerline of the separator radially in outward direction. In the installation position of the water separator, the water outlet 30 is positioned at the lowest point in the circumference of the water separator, as illustrated in FIG. 2, for example.

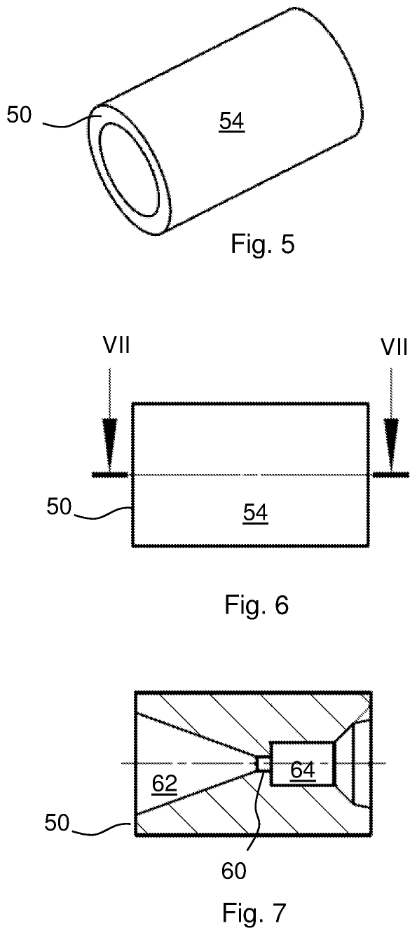

FIGS. 5 through 7 show a first embodiment of a throttle element 50, wherein FIG. 5 shows an isometric view, FIG. 6 a side view, and FIG. 7 a view of a section plane along the line VII-VII illustrated in FIG. 6 through the throttle element 50 of FIG. 5.

In a first channel section 62 in flow direction, the throttle element 50 includes a tapering, in particular conical, inflow cross section adjoined by the actual throttle region of the constriction 60. This throttle region, in relation to the length of the entire throttle element 50, can be embodied as a short cylindrical section. Downstream of the throttle region with the constriction 60, a cylindrical channel section 64 adjoins with a cross section that is expanded in relation to the constriction. The cross section of the channel section 64 expands further in sections in flow direction toward the end of the throttle element 50.

In the interior region, the constriction 60 is arranged between two channel sections 62, 64. The outer wall 54 of the throttle element 50 is embodied cylindrical and smooth. This configuration is possible for a heated insert method for embedding the throttle element 50 in the water outlet in case that the throttle element is enclosed at least partially in longitudinal direction by the material of the water outlet 30.

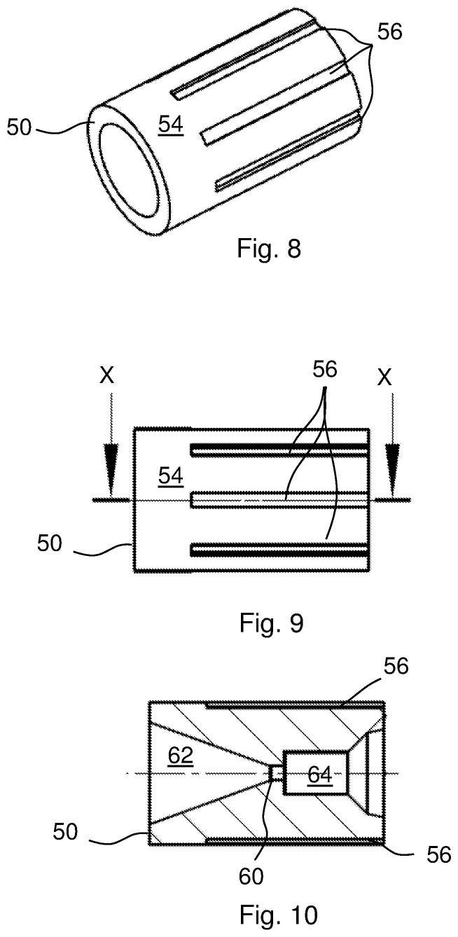

FIGS. 8 to 10 show a further embodiment of a throttle element 50, wherein FIG. 8 is an isometric view, FIG. 9 a side view, and FIG. 10 a plan view of a section plane along the line X-X illustrated in FIG. 9 through the throttle element 50 of FIG. 8.

In the interior, the constriction 60 is arranged between two channel sections 62, 64. The outer wall 54 of the throttle element 50 is cylindrically embodied and includes axially oriented corrugations 56. This configuration is beneficial for an injection molding method for embedding the throttle element 50 in the water outlet 30.

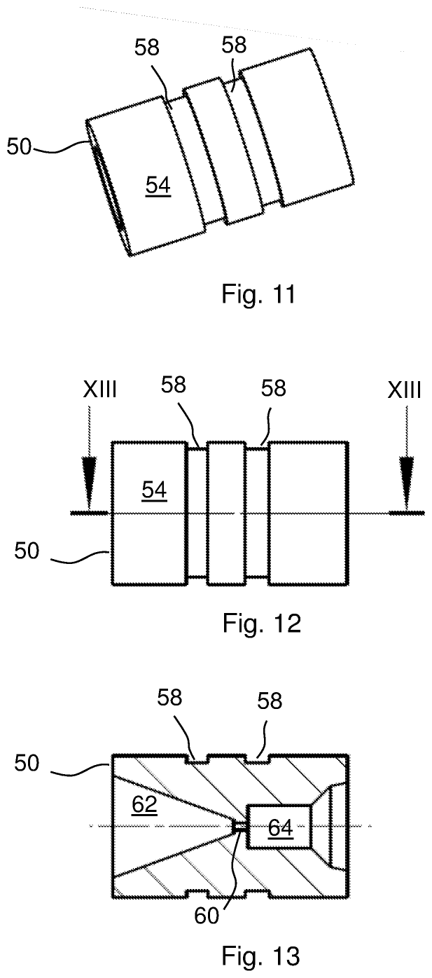

FIGS. 11 to 13 show a further embodiment of a throttle element 50, wherein FIG. 11 shows an isometric view, FIG. 12 a side view, and FIG. 13 a plan view of a section plane along the line XIII-XIII illustrated in FIG. 12 through the throttle element 50 of FIG. 11.

In the interior, the constriction 60 is arranged between two channel sections 62, 64. The outer wall 54 of the throttle element 50 is embodied cylindrically and includes circumferentially extending grooves 58. This configuration is beneficial for an injection molding method for embedding the throttle element 50 in the water outlet 30.

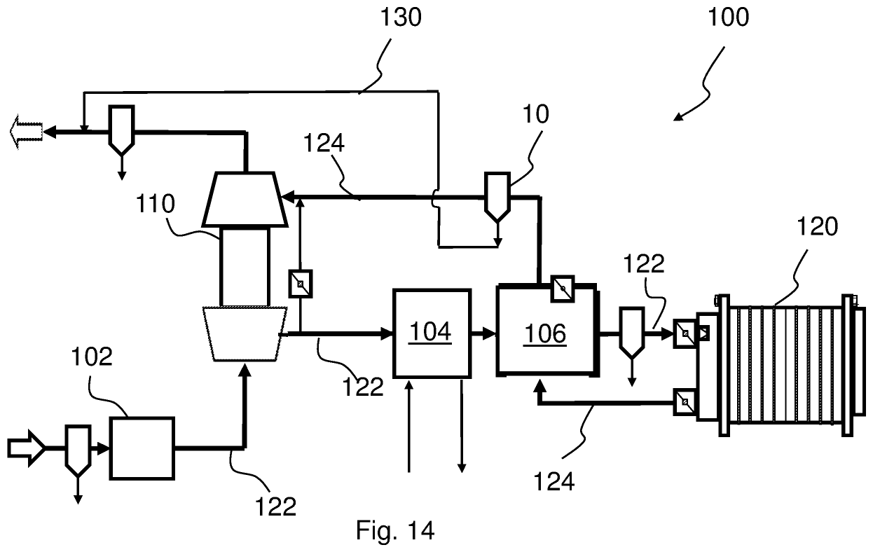

FIG. 14 shows a simplified illustration of a generally known fuel cell system 100 with a fuel cell unit 120 with a cathode supply air path 122 and a cathode exhaust air path 124. Via the cathode supply air path 122, ambient air is supplied to the fuel cell unit 120, which ambient air is filtered by a cleaning stage 102 and sucked in via a compressor of a turbocharger 110 and compressed. The compressed air is cooled in a heat exchanger 104 and provided with a defined moisture by a humidifier 106.

In the fuel cell unit 120, the oxygen from the air reacts with hydrogen to water that is discharged as an air/water mixture via the cathode exhaust air path 124 from the fuel cell unit 120. The cathode exhaust air can transfer a portion of the water in the humidifier 106 to the cathode supply air. Downstream of the humidifier, a water separator 10 is connected which is embodied according to the aforementioned embodiments and in particular includes a flow-conducting throttle element 50 which is embedded in the water outlet 30 of the water separator 10. The separated water is discharged in a drainage path 130 while the dried cathode exhaust air is supplied to the turbine of the turbocharger 110.

Positioning of the water separator 10 upstream of the turbine of the turbocharger 110 is particularly beneficial. Through the throttle element 50, the loss of cathode exhaust air can be reduced, which is energetically beneficial for the operation of the turbocharger 110. The throttle element 50 reduces the fluid flow in the drainage path 130 which would be impermissibly large without the throttle element due to the different pressure levels upstream and downstream of the turbine.

Further water separators, not identified in detail, are illustrated in the fuel cell system 100. They can also include such a throttle element but can also be embodied without one.

In such a system, the loads of the water separator 10 in operation are high. A significant pressure loss at the water separator 10 up to several bars can occur. The cathode exhaust air flowing through the water separator 10 can reach in this region a speed near the speed of sound of the fluid, in particular at least 90% of the speed of sound, or can even surpass the speed of sound, wherein temperatures up to 100° C. are possible.

Due to the use of a water separator 10 with a throttle element 50 embedded in the water outlet, advantageously a stable permanent operation can be achieved despite such high loads. The throttle element 50 can be embodied of a resistant material while a material which is not of such high quality can be employed for the water separator 10.

1. A water separator comprising:
a flow-conducting interior; and
a water outlet connected to the flow-conducting interior, the water outlet comprising a throttle element that is inserted in the water outlet and configured to conduct water flow into the throttle element,
wherein the throttle element comprises:
a first channel section comprising a conical section tapering in a direction of the water flow into the first channel section;
a constriction directly connected to an output of the first channel section, the constriction comprising a cylindrical section; and
a cylindrical channel section directly connected to an output of the constriction, the cylindrical channel section having a cross-section that is larger than a cross-section of the constriction.

2. The water separator according to claim 1, wherein the cross-section of the cylindrical channel section becomes larger in the direction of the water flow into the first channel section to an end of the throttle element.

3. The water separator according to claim 1, wherein the throttle element is inserted in the water outlet by heat-set insertion or by injection molding.

4. The water separator according to claim 1, wherein the constriction has a diameter between 1 mm and 4 mm.

5. The water separator according to claim 4, wherein the diameter is between 1.5 mm and 3 mm.

6. The water separator according to claim 1, wherein the throttle element is formed of one among metal, plastic, and ceramic.

7. The water separator according to claim 1, wherein the throttle element comprises an outer wall having a cylinder shape.

8. The water separator according to claim 7, wherein the outer wall comprises an outer circumference comprising one or more corrugations that are oriented in an axial direction of the outer wall.

9. The water separator according to claim 7, wherein the outer wall comprises an outer circumference comprising one or more circumferential grooves.

10. The water separator according to claim 7, wherein the outer wall comprises an outer circumference comprising a knurled structure.

11. The water separator according to claim 1, wherein the water outlet is arranged tangentially in a spin direction of the water separator.

12. The water separator according to claim 1, wherein the water outlet is arranged radially in an outward direction and arranged at an angle relative to a longitudinal axis of the water separator.

13. The water separator according to claim 1, further comprising a funnel-shaped region connecting the water outlet to the flow-conducting interior.

14. A fuel cell system comprising:
a fuel cell unit;
a cathode supply air path connected to the fuel cell unit;
a cathode exhaust air path connected to the fuel cell unit; and
the water separator according to claim 1,
wherein the water separator is arranged in the cathode exhaust air path and is configured to limit an air flow in a drainage path of the water separator.
